(19) United States
(12) Patent Application Publication
(10) Pub. No.: US 2005/0028886 A1
(43) Pub. Date: Feb. 10, 2005

(54) In line filling machine

(76) Inventors: Ramon M. Navarro, Orange, CA (US); Gilbert L. De Cardenas, Industry, CA (US)

Correspondence Address: BRENEMAN & GEORGES, 3150 Commonwealth Avenue, Alexandria, VA, 22305, US

(21) Appl. No.: 10/633,547

(22) Filed: Aug. 5, 2003

(51) Int. Cl. B67C 3/00

(52) U.S. Cl. 141/129

(57) ABSTRACT

The invention provides a novel in line filling machine having the ability to accurately meter and dispense into a plurality of containers a metered volume of fluid from a common product reservoir. The novel in line filling machine includes a plurality of product dispensing cylinders and pistons in which the ends of the pistons are interconnected by an adjustable rack for controlling the position and advancement of all of the pistons simultaneously in the product dispensing cylinders. An individual adjustment means is provided on each of the individual pistons for precisely adjusting the position of each individual piston in the product-dispensing cylinder to accurately meter fluid into a plurality of containers. The support stand for the novel in line filling machine can be modified to include a single or dual conveyor arrangement to simultaneously fill a plurality of containers on parallel production lines.

### BACKGROUND OF THE INVENTION

1. Field of the Invention

The invention pertains to a novel in line filling machine having a common reservoir connected to a plurality of product dispensing valves which are connected to a plurality of individual product metering fill pistons having piston rods which are interconnected by a common rack or adjustable means which interconnects the plurality of product dispensing pistons to simultaneously dispense a metered quantity of the product through the plurality of valves into a plurality of containers on a conveyor operated by the filling machine. The novel filling machine is designed to accurately meter a precise quantity of a fluid material into individual containers having the same quantity of fluid material and provide for the accurate and simultaneous adjustment of the individual product metering pistons for rapid changeover. In its preferred application, the invention pertains to an ascetic in line filler for filling bottles or containers with cream, yogurt or other food or pharmaceutical material requiring the highest degree of purity and sanitary handling conditions which require the novel machine to be free of seams, cracks, crevices or other surface imperfections that would lead to the growth of deleterious substances such as bacteria or provide a haven for undesirable substances or product residues. As a result, the novel in line filling cleaning machine includes detachable components and a novel cleaning element for reaching down into and through manifolds and into product dispensing valves to provide for the cleaning of the novel in line filler machine.

The novel in line filling machine achieves its advantages in metering precise quantities of dispensed fluids from a common reservoir into a plurality of bottles or containers by utilizing a plurality of adjustable and interconnected metering pistons actuated by an adjustable rack that engages each of the ends of the plurality of product dispensing pistons and provides for the simultaneous adjustment of the plurality of product dispensing pistons so that upon activation, each of the product dispensing pistons each deliver simultaneously the same amount of fluid to each of the bottles or containers disposed on a conveyor beneath the novel in line filling machine. Adjustment of the plurality of product dispensing pistons is provided by a product dispensing piston cylinder combination that utilizes a threaded adjustment screw for setting the position of the piston and cylinders. Further advantages to the invention include the ability to adjust each piston in the adjustable rack to provide the precise metering of a fluid fill material which includes pharmaceutical products, dairy products such as cream, yogurt or fill dairy products in which high standards of purity and precise volume control of dispensed product is desired for simultaneously metering fluids into a plurality of containers.

2. Description of the Related Art, Including Information Disclosed Under 37 C.F.R. 1.97 and 1.98

The prior art includes a variety of filling machines, which include various types of metering nozzles and valves for controlling the amount of product dispensed in a container. Some of these dispensing machines are dispensed by volume or weight in order to more precisely control the amount of fluid dispensed and provide for rapid changeover and cleaning for dispensing foodstuffs and pharmaceutical products.

Examples of prior art metering and filling of multiple containers in an aseptic environment include Groninger U.S. Pat. No. 4,993,598, Kleinophorst Geb. Schraedel, et al. Miller, et al. U.S. Pat. No. 4,913,202 and Gentile U.S. Pat. No. 5,295,523. Groninger U.S. patent provides a rotary fill table with rotary fill pistons operating vertically in a employ an adjustable rack for simultaneously adjusting a plurality of pistons to meter dispensed fluid in a plurality of containers. Kleinophorst Geb. Schraedel, et al. employs a volume chamber in each supply line with an impeller that has a shaft that is rotated by the medium flowing to the valve. A flow recorder is connected to the volume chambers so that outputs from the flow recorder of the other volume chambers are applied so that the volume of the first flow recorder is compared with the actual valves of the other flow recorders so that when the desired values are reached the valves are disconnected. Kleinophorst Geb. Schaedel, et al. U.S. Pat. No. 4,523,616 like Groninger U.S. Pat. No. 4,993,598 does not employ an adjustable rack for simultaneously adjusting a plurality of pistons to meter fluid to a plurality of containers.

The most pertinent prior art pertaining to a combination of adjustable piston cylinder metering is Harrell, et al. U.S. Pat. No. 3,939,883. This prior art for filling insect rearing cells with food includes vertically arranged pistons on a hydraulically operated carrier having an adjustment collar on the driving cylinder and an adjustable collar 30 on each of the metering pistons. Unlike the invention, Harrell, et al. U.S. Pat. No. 3,939,883 does not provide aseptic dispensing, a cleaning manifold, easily dissemblable components or a chair drive with a threaded screw for providing for the adjustment of the entire adjustable rack for accurately metering food products and provide for an in line filling of containers on a conveyor controlled by the filling machine.

Many of the prior art filling machines share the common problem of change over in fill volume or capacity when one size container is substituted for another size container, such set ups invariably take long periods of time to adjust the filling machine to fill different size containers having different volume fill capacities. The invention allows for a rapid change over of fill capacities from one container to another by merely changing the adjustment setting for the plurality of fill cylinder so that the new size or volume container can be filled accurately to a different fill capacity. Accuracy of fill in all of the plurality of containers in provided by a threaded adjustment for simultaneously setting the position of the dispensing volume of all of the dispensing piston cylinder combination.

In addition many of the prior art fill machines suffer the drawbacks of not being easily cleaned during a change over from one type of dispensed product to another, this change over requirement from one type of product to another is easily accommodated in the novel filling machine since all of the components are detachable so that the entire novel machine may be quickly dissembled to provide for cleaning in all crevices as well as potential sterilization of each of the components of the novel in line filling machine. In applications where the same type of fluid is to be dispensed in the machine, a novel wash manifold is provided for cleaning out the novel in line filling machine, which manifold includes fingers for reaching down into and through the individual manifolds and into the product dispensing valves to flush out and clean the valves during periodic or scheduled cleaning operations. The problems underlying the invention is that of accommodating sterilization of aseptic filling machines while accommodating rapid changeover from one size container to another, increased production line capacity as well as accurate dispensing of fluid over a wide range of fill volumes. These problems involved in the aseptic filling of foodstuffs particularly yogurt, cream, medicines and pharmaceuticals are accommodated by the novel filling machine by accommodating cleaning and rapid accurate adjustment by employing an adjustable rack adjusted by a threaded adjustment means for simultaneously adjusting all the pistons in the cylinders to accurately dispense a fluid fill product in an aseptic filling operation.

### BRIEF SUMMARY OF THE INVENTION

The invention provides for the metered filling of a plurality of containers from a common reservoir utilizing a plurality of fill valves in combination with a plurality of metering fill pistons the ends of which are interconnected by an adjustable rack for positioning the pistons in corresponding fill cylinders to provide for the simultaneous dispensation of the same metered quantity of fill product in a plurality of containers. The adjustable metered filling can be accomplished by adjusting and actuating the position of the pistons with respect to the cylinders or the adjustment of all the cylinders with respect to the pistons or both. Actuation of all the adjusted piston cylinder combination may be achieved by an adjustable rack interconnecting all the cylinders or all the fill pistons or both. The novel combination of fill valves, product fill pistons and cylinders and adjustable rack or adjustable means for interconnecting the ends of the plurality of fill pistons in the fill cylinders provides for simultaneously allowing the adjustment and the dispensing of the same quantity of fluids in a plurality of containers on a conveyor disposed below a plurality of fill nozzles connected to the fill valves.

The novel in line filling machine of the invention is particularly adapted to filling pharmaceutical, dairy and other food products through a fill machine that is easily disassembled and cleaned periodically or at scheduled cleaning intervals. To assist in the cleaning and potential sterilization of the machine, all of the components are fully detachable from each other to allow the components to be taken apart, cleaned and reassembled. In addition, the novel in line filling machine operationally includes a novel cleaning manifold for reaching down into and through product conduits and into product dispensing valves to assist in the periodic cleaning of the novel in line filling machine.

The product dispensing pistons and cylinders of the novel in line filling machine are also detachably connected to the fill valves for disassembly and cleaning. The novel in line filling machine, preferably provides the interconnection of all of the disassembable components by utilizing clamps and preferably tri-clover clamps for connecting openings in the product reservoir to the product manifold and connecting the product manifold to the product dispensation valve and connecting the product dispensation valve to the product dispensing cylinder as well as connecting the discharge ports to each of the detachable fill nozzles. All of the components are preferably made of stainless steel or other material that is smooth and without welds, seams, cracks or other surface imperfections such as would allow the containment of particles or allow deleterious substances to accumulate and form on the surface of any of the components of the novel in line filling machine. As a result, in the preferred embodiment, the table and all of the components are made of seamless, high quality stainless steel to prevent any part of the novel in line filling machine to serve as a host for the growth of bacteria or other deleterious substance.

The novel in line filling machine preferably includes a common product reservoir supported by a support stand. The common product reservoir preferably includes a plurality of openings for detachably connecting to a plurality of product manifolds which detachably connect to a plurality of product dispensing valves each of the product dispensing valves is detachably connected to a fill nozzle which may include an optional elbow-shaped fitting for allowing the product to be dispensed through the fill nozzle in a substantially vertical plane over a conveyor supporting a plurality of spaced containers for filling.

The product dispensation valves are interconnected to a product dispensation, piston-cylinder combination, which are supported by the support stand and held in an adjustable rack or adjustable means for interconnecting all of the pistons contained within the product dispensation cylinders. The adjustable rack or adjustable means can be designed to engage and adjust all the pistons simultaneously by engaging all of the piston rods and moving all of the rods with respect to the product dispensation cylinders or the adjustable rack or adjustable means can engage all the cylinders and move all the cylinders with respect to the pistons or a combination thereof.

In the preferred embodiment of the invention, the stand also includes adjustable means for simultaneously adjusting all of the pistons within the product cylinders, the product cylinders are designed to receive and meter out the same quantity of fillable product from the product reservoir to the plurality of containers disposed below the product fill nozzles upon the simultaneous actuation of all of the product dispensing pistons. Preferably, the product containers are disposed on a conveyor belt below the product nozzles which conveyor is designed to be controlled by the novel product-filling machine.

The novel in line filling machine can include any number of product fill cylinder combinations common to the number of product dispensation openings in the product fill reservoir. The number and arrangement of the product fill piston-cylinder combinations and product fill nozzles is anywhere from two to twenty and preferably is four to twelve product dispensation piston-cylinders for simultaneously providing for the adjustable metering and dispensing a metered quantity of fluid product in a like number of containers disposed on a conveyor below the product dispensation nozzles.

The novel in line filling machine includes a plurality of product pistons disposed inside the product dispensation cylinders which are interconnected by an adjustable means for positioning each of the product dispensation pistons in the product dispensation cylinders. In the best mode of the invention, the product dispensation pistons are designed to be adjustably positioned within the product dispensation cylinders at various adjustable positions intermediate the ends of the product dispensation cylinders so that the volume of products metered by the product dispensation cylinders can be rapidly changed from one metered volume to another. In addition, each of the novel pistons includes a means for adjustment within the adjustable means so that if one particular piston cylinder combination dispenses a larger or smaller quantity than any other piston cylinder combination the nonconforming metered piston cylinder combination can be individually adjusted within the adjustable rack so that that piston cylinder combination can be adjusted to repeatedly meters the same volume of product as the other product piston cylinders upon activation of the adjustable rack or adjustable means for interconnecting the plurality of interconnected product dispensation pistons.

In a further embodiment of the invention, the novel stand can be modified to include a second adjustable rack or a second adjustable means connected to a second plurality of product dispensing pistons and cylinders laterally disposed from the first adjustable rack or adjustable means for dispensing a metered quantity of product to a second group of product fill nozzles disposed across from the first group of product fill nozzles so that two separate conveyor production lines having containers thereon can be simultaneously filled from a common reservoir. The common reservoir may also be modified to divide two laterally adjacent openings for supplying product to the laterally adjacent piston and cylinder combinations which have individual adjustable racks for adjusting the position of the plurality of interconnected pistons or cylinder for dispensing product into containers on a first conveyor production line and a common and second adjustment means or second adjustable rack for dispensing product from the second set of product dispensing piston and cylinder combination to a second set of containers on a second parallel production line to increase the speed and capacity of the automated filling of containers on the conveyor production lines. In addition, the two conveyor lines can be synchronized by the novel in line product filling machine to synchronously start and stop both the first and second conveyor production lines so that bottles can be simultaneously filled on both production lines synchronously or asynchronously.

These and other advantages of the invention will be more fully appreciated by those skilled in the art with reference to the following brief description of the drawings with reference to the detailed description of the invention.

### BRIEF DESCRIPTION OF THE SEVERAL VIEWS OF THE DRAWINGS

The invention will hereinafter be more fully described with reference to exemplary illustrations of the preferred embodiments of the invention in which:

FIG. 1 which is divided into FIG. 1A and FIG. 1B is an exploded perspective view of a novel in line filling machine constructed in accordance with the best mode of the invention;

FIG. 2 is a front elevational view of the novel in line filling machine of FIG. 1;

FIG. 3 is a side view of the novel in line filling machine of FIG. 2;

FIG. 4 is a perspective view of the novel in line filling machine with fill containers on a conveyor operated by the filling machine in accordance with the preferred embodiment of the invention;

FIG. 5 is a perspective view of an adjustment mechanism for adjusting the position of a product dispensation piston in an adjustable means for interconnecting a plurality of product dispensing pistons;

FIG. 6 is a perspective view of a novel dual in line filling machine with containers on dual conveyors constructed in accordance with an alternative embodiment of the invention;

FIG. 7 is a partially cut away view illustrating a filling machine front view and the back view of the novel dual in line filler with containers on dual conveyors of FIG. 6; and

FIG. 8 is a side elevational view of the novel dual in line filler with containers on dual conveyors of FIG. 7.

FIG. 9 is a perspective view of a novel cleaning element and manifold for cleaning the novel in line filling machine of the invention; and

FIG. 10 is a side elevational view partially illustrating the operation of one of the cleaning arms of the novel cleaning element of FIG. 9.

### DETAILED DESCRIPTION OF THE INVENTION

The invention provides a novel in line aseptic product filling machine which simultaneously meters a precise amount of fluid to be dispensed simultaneously to a plurality of containers each of which contains substantially the same volume of dispensed material. Precise metering of dispensed fluid is achieved through a plurality of product cylinders having a plurality of interconnected pistons for adjusting and providing for the simultaneous activation of a plurality of interconnected product pistons to dispense a fluid product, and in particular, a heavy fluid product such as cream, yogurt, pharmaceuticals or other products that require aseptic handling in a filling machine that can be quickly and easily adjusted to dispense a different fill volume for other sized containers and can be readily cleaned in situ and disassembled for thorough cleaning when different food products are dispensed.

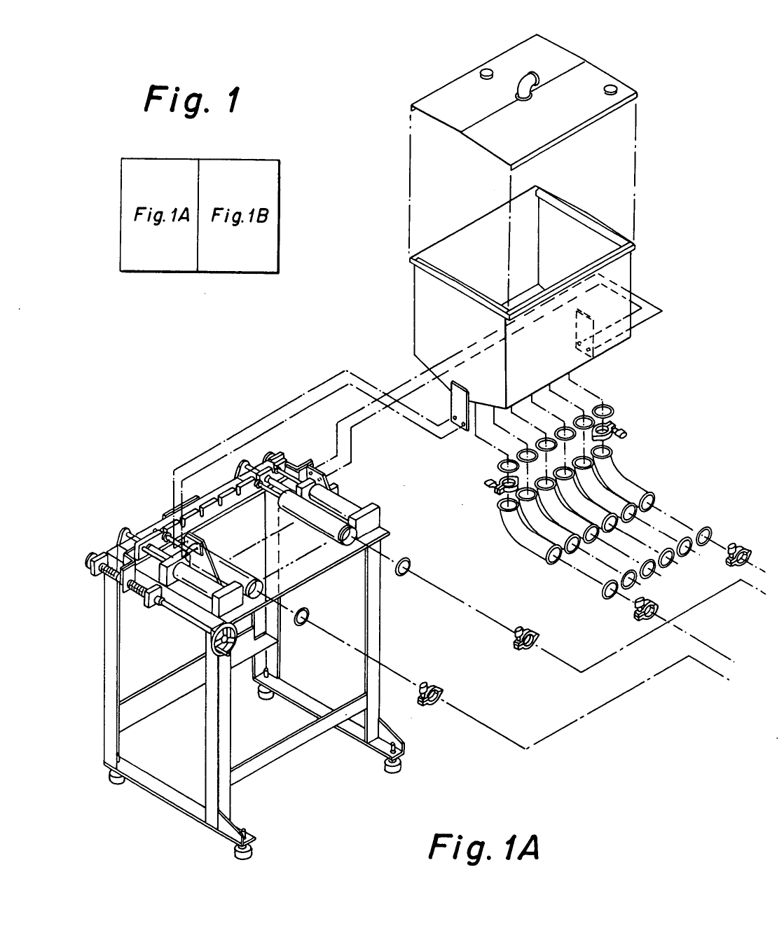

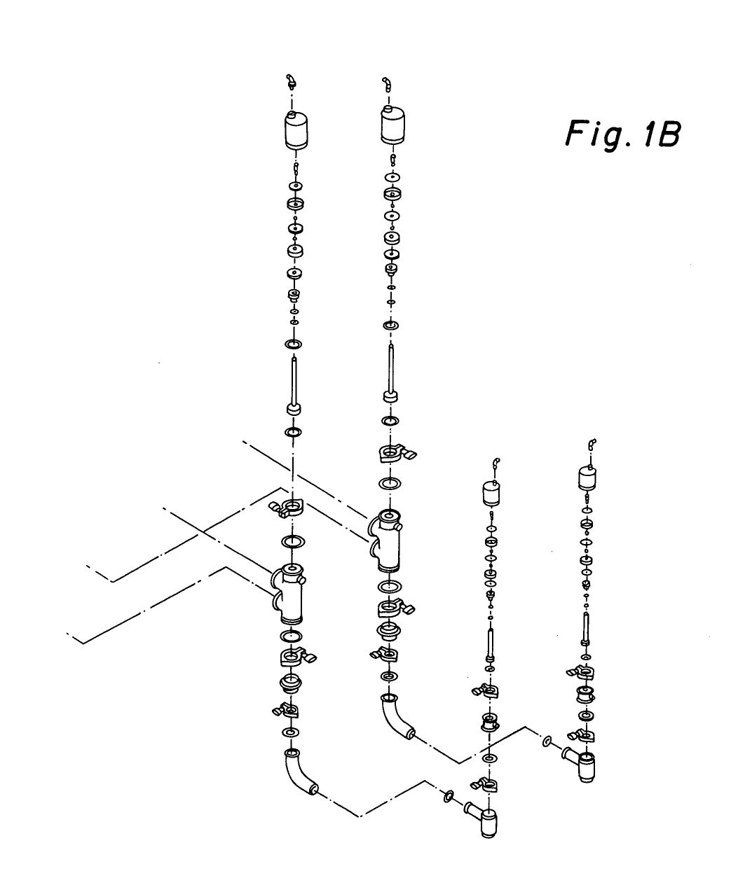

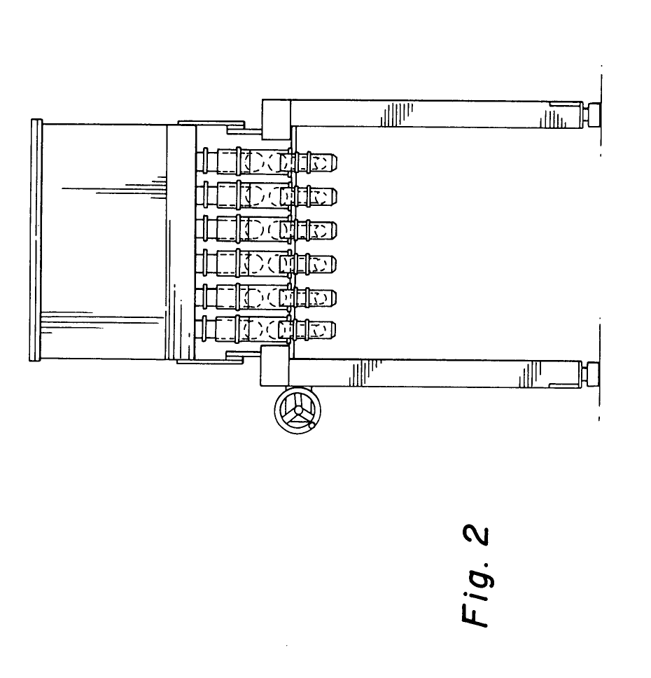

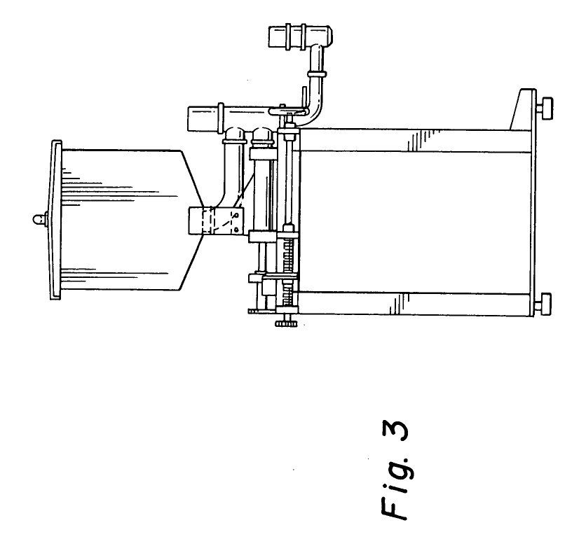

Referring now to FIGS. 1-4 the novel in line filling machine 20 includes a stand 22 for supporting a product reservoir 24 having a plurality of openings for connecting to a plurality of product conduits 28. The connection between the product conduits 28 and the plurality of openings 26 is preferably through a clamp 30 with a sealing O-ring 32. The product conduits 28 are also detachably secured to a product dispensing valve 34 by a clamp 36 and associated O-rings 38. Product dispensing valve 34 is preferably a three-way product dispensing valve as may be obtained from COTT Technologies, Inc. or LaPuente, Calif.

The product dispensing valve is preferably a three-way product valve includes a pneumatic means for operation and associated hardware 40, which is preferably connected to a curved pipe 42 by a clamp 44 which is detachably connected to a product dispensing nozzle 46. Product dispensing nozzle 46 is also preferably pneumatically activated and includes pneumatic associated hardware 48. Product dispensing nozzle 46 is also preferably obtained from COTT Technologies, Inc. and may be obtained under fill valve assembly part number 32120 from COTT Technologies, Inc. of LaPuente, Calif.

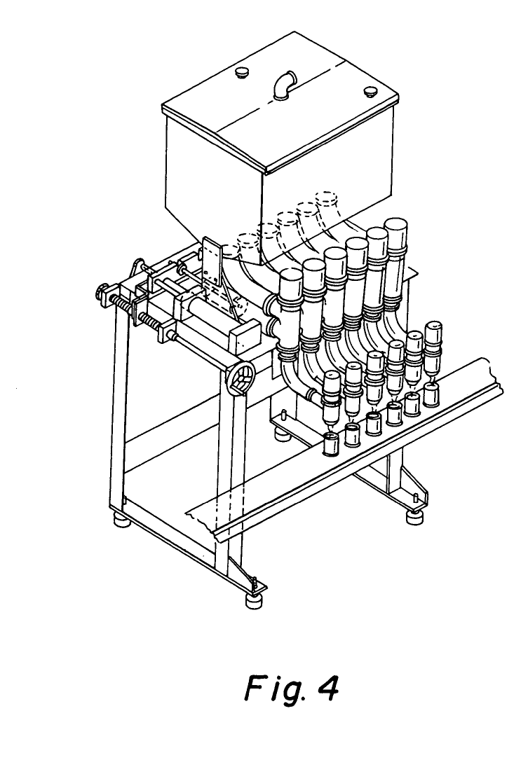

The product-dispensing valve 34 is connected to product dispensing cylinder 50 by a clamp 52 with an associated O-ring 54. Stand 22 is designed to carry a plurality of product dispensing cylinders 50 of a number equal to the number of the plurality of openings 26 in product reservoir 24. The plurality of product dispensing cylinders 50 may be any number greater than two and preferably is in the range of 4 to 12 product cylinders carried by stand 22. Each of the product cylinders includes a product-dispensing piston 56 (FIG. 4). Each product-dispensing piston 56 is connected to an adjustable rack or adjustment means 58 disposed on stand 22. The adjustable rack or adjustable means 58 includes a plurality of slots 60 or other means for interconnecting the ends 62 of each product-dispensing piston 56. The adjustable rack or adjustable means 58 is carried on stand 22 and includes a threaded adjustment screw 64 for adjustably positioning adjustable rack 58 and thereby simultaneously positioning each product dispensing piston 56 in each product dispensing cylinder 50 to meter a precise amount of dispensed fluid through product dispensing valve 34 and into product dispensing nozzle 46.

The threaded adjustment screw 64 can be mechanically activated by an adjustment handle 66 or it can be adjusted electronically by a computer means (not shown) to automatically adjust the position each product dispensing piston 56 in each product dispensing cylinder 50 to precisely meter a predetermined amount of meterable fluid simultaneously into a plurality of containers. Stand 22 also includes a pair of air cylinders 68 which are connected to rack 58 which simultaneously activates each of the product dispensing pistons 56 in product dispensing cylinders 50 to force fluid product through product dispensing valve 34. Upon retraction by air cylinder 68, product from product reservoir 24 is drawn into product dispensing cylinder 50 from the three way product dispensing valve 34 so that the product can be precisely metered into a subsequent container.

The novel in line filling machine 20 is preferably associated with a conveyor 70, the operation of which is controlled by the novel in line filling machine 20 to sequentially advance a plurality of containers 72 beneath each product dispensing novel 46 so that a fillable fluid in common product reservoir 24 is metered simultaneously into a plurality of containers 72 in a precise fill volume of fluid as is set by the position of product dispensing piston 56 in product dispensing cylinder 50. Conveyor 70 is periodically started and stopped in sequence with the filling of the plurality of containers 72. The air cylinders 68 attached to adjustable rack or adjustable means 58 advance the product dispensing pistons 56 in product dispensing cylinders 50 simultaneously dispense fluid into each of the plurality of containers 72 through product dispensing nozzles 46. Adjustable rack or adjustable means 58 simultaneously adjusts the position of each product dispensing piston 56 in each product dispensing cylinder. Thereafter activation of air cylinders 68 not only activates means 58 but also results in threaded adjustment screw 64 sliding over adjustment shaft 74. In the preferred embodiment of the invention, each of the product dispensing nozzles 46 are disposed above a conveyor 70 on which a plurality of containers 72 are precisely filled by the novel in line filling machine. In the preferred embodiment of the invention the advancement of conveyor 70 with containers 72 thereon is controlled by the sequenced filling of the containers by the novel in line filling machine 20.

In the adjustment of adjustable rack or adjustable means 58 threaded adjustment screw 64 includes a sprocket 76 which is connected by a chain 78 to a second sprocket 80 connected to a corresponding threaded adjustment screw 82 for adjusting the position of adjustable rack or adjustable means 58 on stand 22. This adjustment makes certain that each of the ends 62 of each of the product dispensing pistons 56 are maintained in alignment so that the activation of air cylinder 68 results in the uniform advancement of adjustable rack or adjustable means 58. Although it is possible to utilize a single air cylinder 68 in the center of adjustable rack or adjustable means 58, it is preferable to utilize a second air cylinder 68 on the other side of stand 22 to maintain each of the ends 62 of product dispensing pistons in horizontal alignment.

Referring now to FIG. 5 a further adjustment means 84 is provided on adjustable rack or adjustable means 58. The further adjustment means 84 may include any number of means for adjusting the ends 62 of product dispensing piston 56 in adjustable rack or adjustable means 58. One of the possible equivalent structures for providing adjustment of each of the product dispensing pistons in product dispensing cylinders 56 is a threaded end 86 on end 62 and a corresponding threaded bracket 88 for providing a fine adjustment of each product dispensing piston 56 in each product dispensing cylinder 50. A fine adjustment means such as slot 90 may be employed with a set screw 92 to individually adjust each cylinder in adjustable rack or adjustable means 58.

A plurality of other types of adjustment mechanisms are available that may be utilized to individually adjust the position of the product-dispensing piston 56 in product dispensing cylinder 50. The purpose of the individual adjustment of product dispensing piston 56 in product dispensing cylinder 60 is to account for slight variations in diameter, pumping efficiency or any other variables that would cause one individual piston to dispense a volume of metered fluid slightly different than one of the other piston cylinder combinations in the novel in line filling machine.

Referring now to FIGS. 9 and 10 a novel cleaning element 100 is illustrated having a manifold 102 connected to a plurality of cleaning arms 104 for reaching down into and inside each of the product conduits 28 to reach down into and provide a cleaning of the product conduits 28 and each of the product dispensing valves 34. The manifold 102 is connected to a conduit 106 for providing cleaning solution into manifold 102 and down into cleaning arms 104. Cleaning arms 104 may include a series of perforations 108 disposed along the length of cleaning arms 104 for supplying cleaning solution to the interior of the product conduits 28 by providing a spray of cleaning solution 110 along the length of the arm 104 as well as a spray nozzle 112 to spray cleaning solution down into product dispensing valve 34.

As will be recognized by those skilled in the art, cleaning and maintaining the interior of the product reservoir 24 as well as the product conduits 28 as well as the product dispensing valves 34 aseptic is important food, dairy and pharmaceutical preparations where periodic cleaning and quality control is extremely important to maintaining the purity of the dispensed product. In addition, as will be appreciated by those skilled in the art, all of the connections between each of the elements are provided by detachable connections utilizing flanges to allow the entire system to be disassembled, cleaned and sterilized if necessary to maintain the highest purity standards. In addition, a cover 116 is provided for product reservoir 24 to maintain the purity of the product in product reservoir 24. Cover 116 may include a fitting 118 to allow product to be added to the reservoir without removal of cover 116. All of these procedures, including the material which the novel in line filling machine is constructed of is critical in maintaining high purity standards for foods, pharmaceuticals and other critically dispensed products which require a precise metering of the fluids dispensed into a plurality of containers.

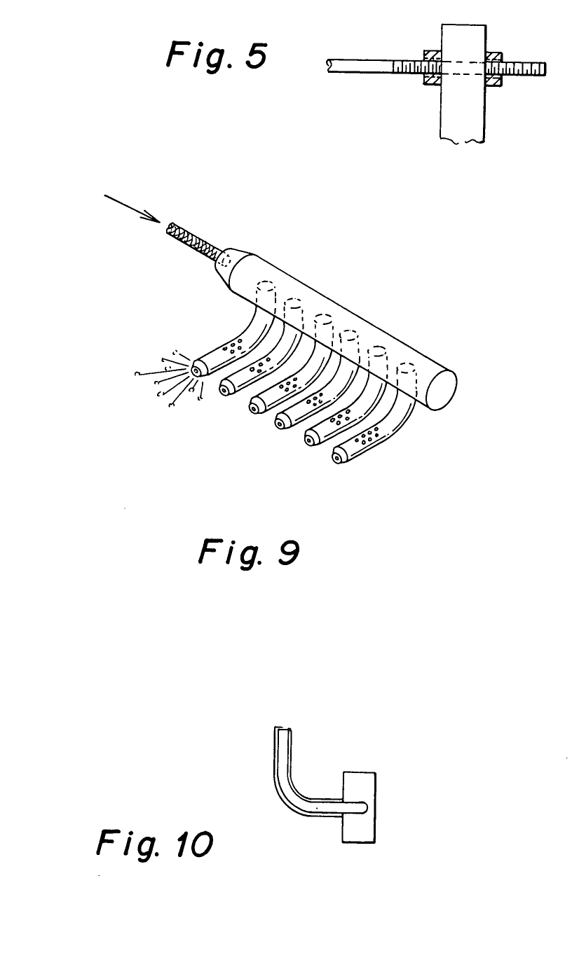

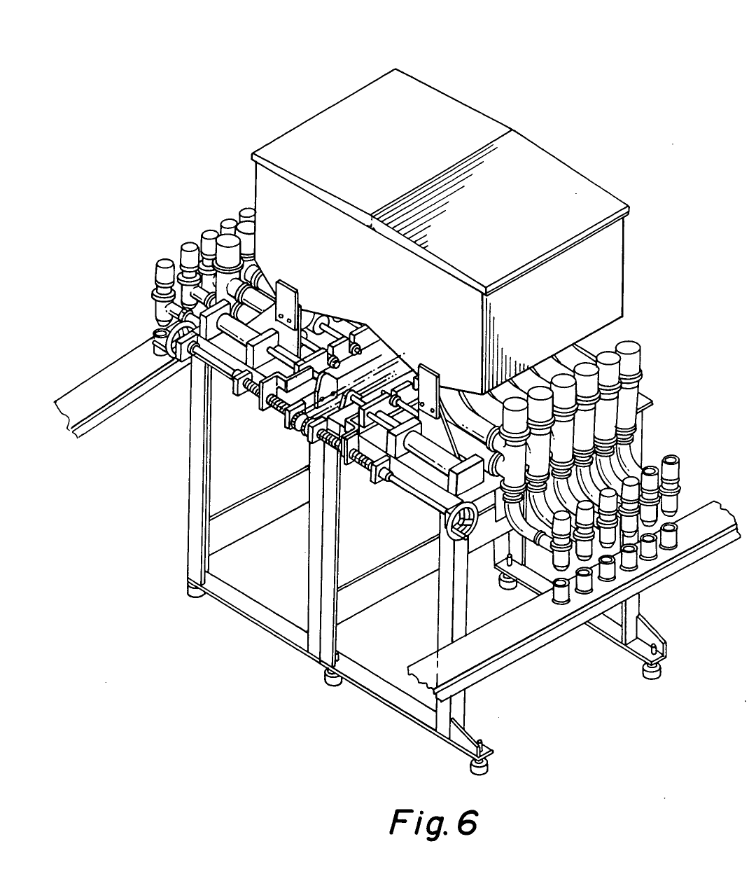

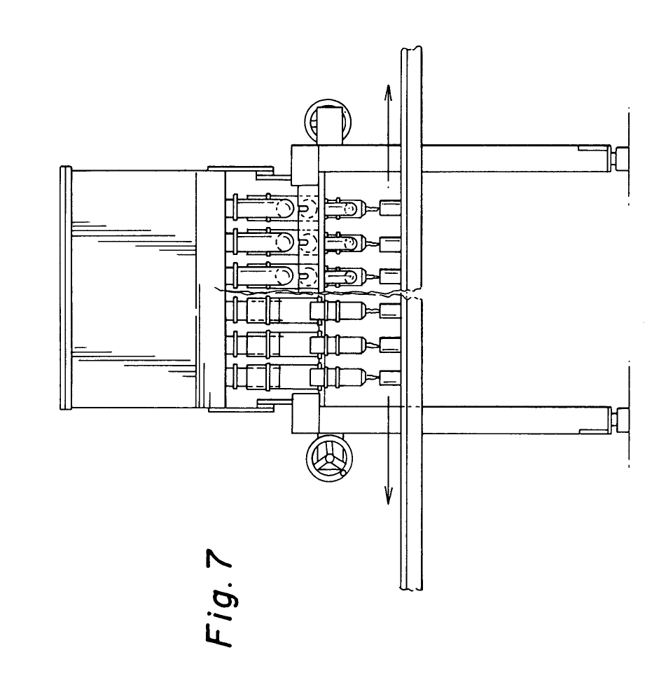

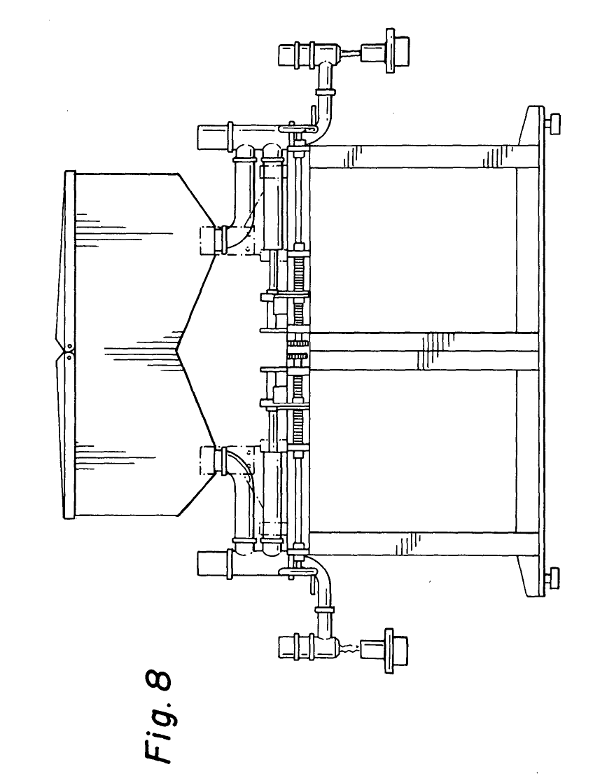

Referring now to FIGS. 6-8 a further embodiment of the invention is illustrated providing for a simultaneous filling of two sets of containers 72 and 120 on two parallel conveyor lines 70 and 122. In this embodiment of the invention, the product reservoir 24 is modified to provide a plurality of openings 26 on one side the product reservoir 24 and a plurality of openings 126 on the other side of product reservoir 24. One set of product conduits 28 are provided on one side of product reservoir 24 and a second set of a plurality of conduits 124 are disposed on the other side of modified reservoir 24. The second set of plurality of conduits are connected to a second set of product dispensing valves 128 and a second set of a plurality of product dispensing nozzles 130.

In this manner, the first set of product dispensing nozzles 46 are disposed over a set of containers 72 on conveyor 70 while the second set of product dispensing nozzles 130 are disposed over a second conveyor 122 having a second plurality of containers 120 for simultaneously dispensing metered amounts of product from a common product reservoir. The dual production line in line filling machine can operate both conveyors 70 and 122 and can either synchronously or asynchronously dispense the same or different volumes of metered fluids in containers 72 and 120. In applications for the asynchronous filling a single adjustable rack or adjustable means 58 can connect the ends of product dispensing pistons so that activation of the rack or means 58 by air cylinders 68 fills containers 72 while product the second set of product cylinders 138 are filled. Thereafter activation of the rack or means 58 in the first set of product cylinders 50 are filled.

In the preferred embodiment of the dual production line, the plurality of containers 72 on conveyor line 70 while second product dispensing nozzles 130 simultaneous dispense metered products to a plurality of bottles or containers 120 on parallel conveyor line 122. In this embodiment both conveyor line 70 and conveyor line 122 are synchronized so that the dispensing of product in both parallel product lines occurs simultaneously with the stopping of conveyor lines 122 and 70. This application of the invention doubles the amount of capacity of the novel in line filler.

In this embodiment, the adjustment for the product dispensing cylinder 50 and product dispensing piston 56 is the same as heretofore described with respect to the single line filler, except that in this embodiment of the invention the double line filler stand 22 is modified to include a second adjustable rack or adjustable means 132 controlled by a second separate adjustment handle 134. In this embodiment the actuation of the second set of product dispensing pistons 136 laterally disposed from the first set of product dispensing pistons provides for the adjustable positioning of the second set of product dispensing pistons 136 in a second set of product dispensing cylinders 138. The adjustment of the second adjustment rack or means 132 is similarly provided by a second adjustment handle 134 which may also be connected to its own separate threaded adjustment screw 140. In a similar manner, each of the second set of product dispensing pistons 136 and second set of product dispensing cylinders 140 may include a separate adjustment means for each of the product dispensing pistons in each of the product dispensing cylinders as heretofore described with respect to FIG. 5.

A second set of air cylinders 142 and 144 may be utilized to activate the second adjustable rack or adjustable means separate from the activation of air cylinders 68 or the activation of the first set of laterally disposed product dispensing pistons and cylinders.

It will be recognized that the present invention has a wide range of applicability and may be modified in a number of ways to suit particular requirements of those skilled in the art. The novel in line filling machine may be modified to utilize a variety of valves and nozzles and may be activated electrically instead of pneumatically. In addition, the novel in line filling machine of the invention may be constructed of glass or other types of sanitary type materials resistant to trapping of deleterious substances and utilizing other materials other than stainless steel.

In addition, as will be recognized by those skilled in the art, the invention may be modified in a variety of ways to suit particular requirements. In addition, the invention may be implemented in a variety of ways other than the best mode as for example where the cylinders are moveable and adjustable to fixed pistons. The invention may also be adapted to synchronize a plurality of in line filling of containers in a plurality of conveyors that may be either sequenced synchronously or asynchronously in the filling operation. In addition, the invention may be modified and adapted to suit particular requirements for the handling of corrosive fluids and may be modified to suit particular requirements of different fluids of different viscosities, as well as the size of the cylinder and piston combination to provide for the precise metering and adjustment of the piston cylinder combination to provide a precise metering of fluids into a plurality of containers from a common product reservoir all of which containers contain the same volume of metered fluid. These and other applications of the invention as can be made by those skilled in the art are intended to be included within the scope of the following claims.

1. A machine for filling containers comprising:
(a) a reservoir having a plurality of openings for containing a fluid product;
(b) a plurality of conduits connected to said plurality of openings;
(c) a plurality of product dispensing valves with each of the product dispensing valves connected to one of each of said plurality of conduits;
(d) a plurality of product dispensing pistons and cylinders with each of said product dispensing cylinders connected to one of said product dispensing valves;
(e) an adjustable rack having a threaded adjustment for setting the position of the rack and an engaging opening for interconnecting said plurality of product dispensing pistons and cylinders to simultaneously adjust each of said plurality of product dispensing pistons and cylinders with respect to each other and providing for the simultaneous dispensing of a fluid product disposed in said plurality of product dispensing cylinders; and
(f) a conveyor line for supporting and advancing a plurality of containers to be filled from said product dispensing cylinders operated by the filling machine.

2. The machine of claim 1 further comprising a plurality of product dispensing nozzles connected to the ends of said product dispensing valves.

3. The machine of claim 1 further comprising a support stand for supporting said reservoir and said adjustable rack.

4. The machine of claim 3 further comprising a plurality of product dispensing nozzles connected to the ends of said product dispensing valves.

5. The machine of claim 4 further comprising a threaded shaft connected to said adjustable rack for adjusting the position of said product dispensing pistons.

6. The machine of claim 3 further comprising a plurality of threads for individually adjusting the position of each of said plurality of product dispensing pistons in said adjustable rack.

7. The machine of claim 1 further comprising a second plurality of product dispensing pistons and cylinders with each of said second plurality of product dispensing cylinders connected to one of said product dispensing valves said second plurality of product dispensing pistons and cylinders disposed laterally adjacent to said plurality of product dispensing pistons and cylinders.

8. The machine of claim 7 further comprising a second adjustable rack having an engaging opening for interconnecting said second plurality of product dispensing pistons and cylinders to simultaneously adjust each of said second plurality of product dispensing pistons in said second plurality of product dispensing cylinders.

9. The machine of claim 7 further comprising a plurality of threads for individually adjusting the position of each of said second plurality of product dispensing pistons in said second adjustable rack.

10. The machine of claim 7 further comprising a plurality of product dispensing nozzles connected to the ends of said product dispensing valves.

11. The machine of claim 7 wherein said plurality of product pistons and cylinders and said second plurality of product pistons and cylinders provide for the filling of containers on two separate conveyor lines.

12. A product filler machine comprising:
(a) a product reservoir having a plurality of openings;
(b) a plurality of product dispensing valves with each of said product dispensing valves connected to one of said plurality of openings;
(c) a plurality of product dispensing pistons and cylinders with each of said product dispensing cylinders connected to one of said product dispensing valves; and
(d) adjustable means for interconnecting said plurality of product dispensing pistons to simultaneously adjust each of said plurality of product dispensing pistons in each of the plurality of product dispensing cylinders.

13. The product filler machine of claim 12 wherein said connection between said product reservoir and said product dispensing valves is connected by a flange clamp.

14. The product filler machine of claim 12 wherein said connection between said product dispensing cylinders and said product dispensing valves is connected by a flange clamp.

15. The product filler machine of claim 12 further comprising a cleaning manifold having a plurality of cleaning arms for disposition in said plurality of openings in said product reservoir and reaching down into and cleaning said plurality of product dispensing valves.

16. The product filler machine of claim 15 further comprising a curved conduit disposed between plurality of openings in said product reservoir and said plurality of product dispensing valves.

17. The product filler machine of claim 16 wherein said plurality of cleaning arms is curved for reaching through said curved conduit to reach down into and clean said plurality of product dispensing valves.

18. The product filling machine of claim 12 wherein said plurality of product dispensing valves are a plurality of three-way valves.

19. The product filling machine of claim 18 further comprising a plurality of product dispensing nozzles connected to the ends of said product dispensing valves.

20. The product filling machine of claim 19 wherein said plurality of product dispensing valves and said plurality of product dispensing nozzles are pneumatically operated.

21. A fluid metering machine comprising:
(a) a support stand;
(b) a fluid product reservoir having a plurality of openings disposed above said support stand;
(c) a plurality of detachable conduits detachably connected to said plurality of openings;
(d) a plurality of detachable product dispensing valves with one of each of said plurality of detachable product valves detachably connected to one of said plurality of detachable conduits;
(e) a plurality of detachable product dispensing cylinders with each of said plurality of detachable product dispensing cylinders detachably connected to one of said plurality of detachable product dispensing valves;
(f) a plurality of product dispensing of pistons with each of said plurality of product dispensing pistons disposed in each of said detachable product dispensing pistons; and
(g) adjustment means disposed on said support stand for simultaneously adjusting each of said plurality of product dispensing pistons in said plurality of detachable product dispensing cylinders.

22. The fluid metering machine of claim 21 further comprising a plurality of detachable product dispensing nozzles detachably connected to said plurality of detachable product dispensing valves.

23. The fluid metering machine of claim 21 further comprising means for individually adjusting the position of each of said plurality of product dispensing pistons in each of said plurality of detachable product dispensing cylinders.

24. The fluid metering machine of claim 22 wherein said plurality of detachable product dispensing valves and said plurality of product dispensing nozzles are pneumatically operated.

25. The fluid metering machine of claim 24 wherein said plurality of product dispensing nozzles are in horizontal alignment.

26. The fluid metering machine of claim 25 wherein said plurality of product dispensing nozzles are disposed above a conveyor.

27. The fluid metering machine of claim 26 wherein the operation of said conveyor is controlled by the fluid metering machine.

28. The fluid metering machine of claim 25 further comprising a second set of a plurality of detachable product dispensing cylinders detachably connected to a second set of a plurality of detachable product dispensing valves, said second set of a plurality of detachable product dispensing cylinders disposed laterally adjacent to said plurality of detachable product dispensing cylinders.

29. The fluid metering machine of claim 28 further comprising a second set of a plurality of product dispensing pistons with each of said second set of a plurality of product dispensing pistons disposed in one of said second set of a plurality of detachable product dispensing cylinders.

30. The fluid metering machine of claim 29 further comprising a second adjustment means for simultaneously adjusting each of said second set of a plurality of product dispensing pistons in said second set of a plurality of detachable product dispensing cylinders.

31. The fluid metering machine of claim 30 further comprising a second set of a plurality of detachable product dispensing nozzles detachably connected to said plurality of detachable conduits.

32. The fluid metering machine of claim 31 further comprising a first conveyor disposed below said plurality of detachable product dispensing nozzles and a second conveyor disposed below said second set of a plurality of detachable product dispensing nozzles.

33. The fluid metering machine of claim 32 wherein the operation of said first conveyor and said second conveyor is controlled by the fluid metering machine.
